(19) United States
(12) Patent Application Publication
(10) Pub. No.: US 2026/0244617 A1
(43) Pub. Date: Aug. 20, 2026

(54) ELECTRONIC DEVICES AND SEARCH METHODS

(71) Applicant: Samsung Electronics Co., Ltd., Suwon-si (KR)

(72) Inventors: Jeongpyo LEE, Suwon-si (KR); Dohyeon KIM, Suwon-si (KR); Soonsang PARK, Suwon-si (KR); Minji SON, Suwon-si (KR); Junseok LEE, Suwon-si (KR); Yonggil HAN, Suwon-si (KR)

(21) Appl. No.: 19/647,194

(22) Filed: Apr. 14, 2026

Related U.S. Application Data
(63) Continuation of application No. PCT/KR2024/015120, filed on Oct. 4, 2024.

(30) Foreign Application Priority Data
Oct. 25, 2023 (KR) 10-2023-0144137
Nov. 27, 2023 (KR) 10-2023-0167141

(51) Int. Cl. G06F 16/245; G06F 16/215

(52) U.S. Cl. CPC G06F 16/245; G06F 16/215

(57) ABSTRACT

A method performed by an electronic device is provided. The method includes receiving, by the electronic device, a search word from a user, estimating, by the electronic device, a keyboard layout of a keyboard utilized for inputting the search word, selecting, by the electronic device, an index word in which a distance to the search word is less than a threshold value, on the basis of the keyboard layout, obtaining, by the electronic device, a search result corresponding to each of the index word and the search word, and returning, by the electronic device, the search result in response to the search word.

### CROSS-REFERENCE TO RELATED APPLICATION(S)

This application is a continuation application, claiming priority under 35 U.S.C. § 365(c), of an International application No. PCT/KR2024/015120, filed on Oct. 4, 2024, which is based on and claims the benefit of a Korean patent application number 10-2023-0144137, filed on Oct. 25, 2023, in the Ministry of Intellectual Property (MOIP), and of a Korean patent application number 10-2023-0167141, filed on Nov. 27, 2023, in the Ministry of Intellectual Property (MOIP), the disclosure of each of which is incorporated by reference herein in its entirety.

### BACKGROUND

### 1. Field

The disclosure relates to an electronic device and search methods.

### 2. Description of Related Art

Typo-correction search is a technology that uses an automatic correction mechanism to return correct search results when a user enters a search word including a typo or a spelling error. Typo-correction search may be a technology required by search engines to improve user experience and enhance accuracy of search results.

Typo-correction search technology may use pre-built dictionaries or language models to provide correct word or correction suggestions. Typo-correction search technology may use correction mechanisms based on an edit distance (e.g., Levenshtein distance) between an input search word and a candidate word.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and search methods.

Additional aspects will be set forth in part in the description which follows and, in part, will be apparent from the description, or may be learned by practice of the presented embodiments.

In accordance with an aspect of the disclosure, an operation method of an electronic device is provided. The operation method includes receiving, by the electronic device, a search word from a user, estimating, by the electronic device, a keyboard layout of a keyboard used to input the search word, selecting, by the electronic device, an index word in which an adjacency distance to the search word is less than a threshold value, based on the keyboard layout, obtaining, by the electronic device, a search result corresponding to each of the index word and the search word, and returning, by the electronic device, the search result in response to the search word.

In accordance with another aspect of the disclosure, an electronic device is provided. The electronic device includes memory, comprising one or more storage media, storing instructions, and one or more processors communicatively coupled to the memory, wherein the instructions, when executed by the one or more processors individually or collectively, cause the electronic device to receive a search word from a user, estimate a keyboard layout of a keyboard used to input the search word, select an index word in which an adjacency distance to the search word is less than a threshold value, based on the keyboard layout, obtain a search result corresponding to each of the index word and the search word, and return the search result in response to the search word.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, a search word from a user, estimating, by the electronic device, a keyboard layout of a keyboard used to input the search word, selecting, by the electronic device, an index word in which an adjacency distance to the search word is less than a threshold value, based on the keyboard layout, obtaining, by the electronic device, a search result corresponding to each of the index word and the search word, and returning, by the electronic device, the search result in response to the search word.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIGS. 2 and 3 are schematic block diagrams of an electronic device according to various embodiments of the disclosure;

FIGS. 4A and 4B are diagrams illustrating types of keyboards according to various embodiments of the disclosure;

FIGS. 5A, 5B, 5C, and 5D are diagrams illustrating keyboard layouts according to various embodiments of the disclosure;

FIG. 6 is a diagram illustrating a method of estimating a keyboard layout according to an embodiment of the disclosure;

FIGS. 7A and 7B are diagrams illustrating a method of estimating a keyboard layout according to various embodiments of the disclosure;

FIG. 8 is a diagram illustrating an index word dictionary according to an embodiment of the disclosure;

FIGS. 9A, 9B, and 9C are diagrams illustrating an operation of calculating an adjacency distance according to various embodiments of the disclosure;

FIG. 10 is an example of a search result returned by an electronic device according to an embodiment of the disclosure; and

FIG. 11 is a flowchart illustrating an operation method of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the spirit and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

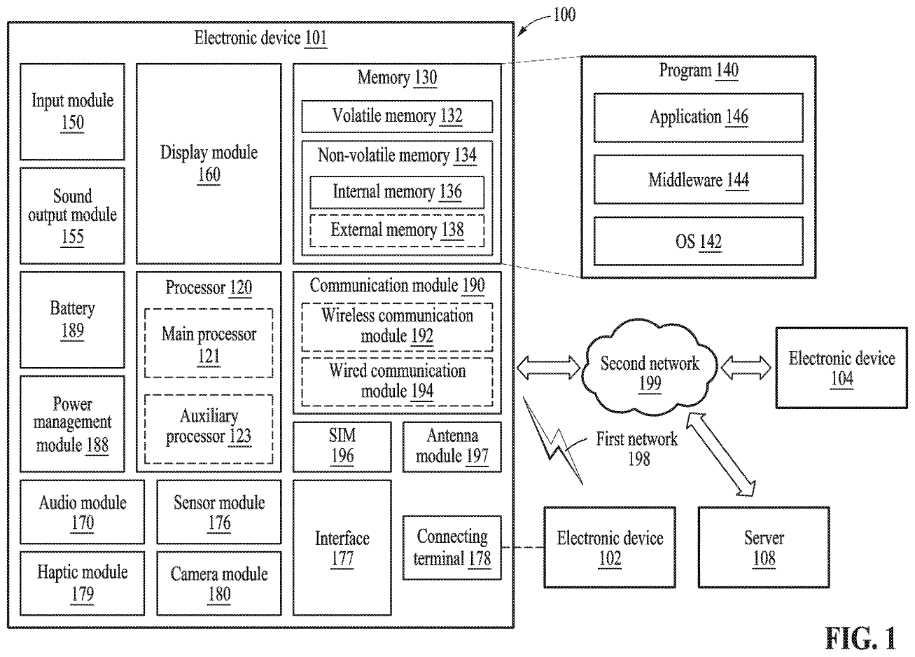

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134.

According to an embodiment, the processor 120 may be implemented as circuitry (e.g., processing circuitry) such as a system on chip (SoC) or an integrated circuit (IC). The processor 120 may include one or more processors. For example, the processor 120 may include a combination of one or more processors, such as a central processing unit (CPU), a graphics processing unit (GPU), a microprocessor unit (MPU), an application processor (AP), and a communication processor (CP).

According to an embodiment, the processor 120 may include a main processor 121 (e.g., a CPU or an AP), or an auxiliary processor 123 (e.g., a GPU, a neural processing unit (NPU), an image signal processor (ISP), a sensor hub processor, or a CP) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof, but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto.

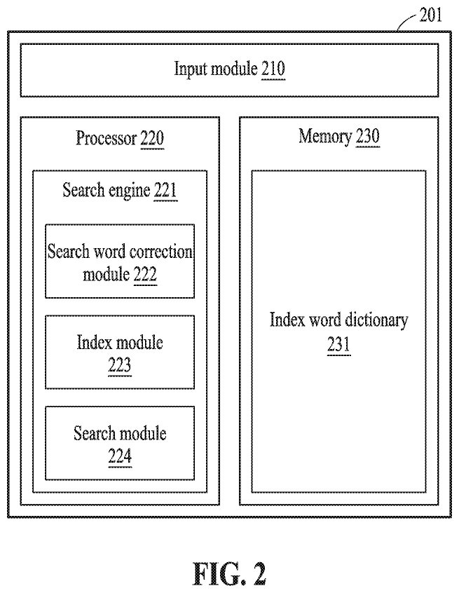

According to an embodiment, the memory 130 may include one or more memories. Instructions stored in the memory 130 may be stored in single memory. Instructions stored in the memory 130 may be divided and stored in a plurality of memories. Instructions stored in the memory 130 may be individually or collectively executed by the processor 120 to cause the electronic device 101 (e.g., the electronic device 201 of FIG. 2) to perform and/or control a search method described with reference to FIGS. 2, 3, 4A, 4B, 5A to 5D, 6, 7A, 7B, 8, 9A to 9C, 10, and 11. Instructions stored in the memory 130 may be individually or collectively executed by a plurality of processors to cause the electronic device 101 (e.g., the electronic device 201 of FIG. 2) to perform and/or control the search method described with reference to FIGS. 2, 3, 4A, 4B, 5A to 5D, 6, 7A, 7B, 8, 9A to 9C, 10, and 11. According to an embodiment, the memory 130 may include the volatile memory 132 or the non-volatile memory 134. The non-volatile memory 134 includes internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing a recording. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or headphones) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of the same type as, or a different type from, the electronic device 101. According to an embodiment, all or some of operations to be executed at the electronic device 101 may be executed at one or more of the external electronic devices 102, 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart homes, smart cites, smart cars, or healthcare) based on 5G communication technology or IoT-related technology.

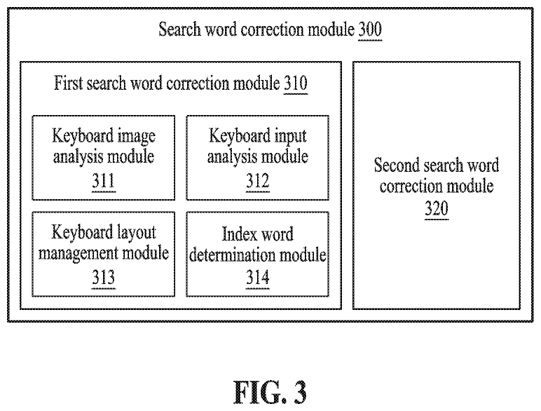

FIGS. 2 and 3 are schematic block diagrams of an electronic device according to various embodiments of the disclosure.

According to an embodiment, an electronic device 201 may support a keyboard fuzzy function. The keyboard fuzzy function may be designed to prepare for a situation where a user accidentally presses an adjacent key. The keyboard fuzzy function may be designed to consider a type of a keyboard.

In an embodiment, the electronic device 201 may extend the keyboard fuzzy function that is previously limited to a qwerty keyboard. The electronic device 201 may estimate a layout of a keyboard. The electronic device 201 may select an index word (e.g., one of index words processed for search) in which an adjacency distance to a search word (e.g., an input of a user) is less than a threshold value, based on the estimated layout. The electronic device 201 may return a search result corresponding to the input of the user by using the selected index word.

Depending on a type (e.g., a qwerty type, a qwertz type, an azerty type, a 3*4 type, or a Chunjiin type) of the keyboard, a physical arrangement of keys included in the keyboard may be different. There are many different types of keyboards around the world, and the types may be designed to accommodate languages and characters used in a particular country or region. The type of the keyboard may help typo-correction search technology understand an input of a user.

In an embodiment, a keyboard layout may have different values depending on the type of the keyboard. The keyboard layout may include a vector corresponding to a key included in the keyboard. The vector may include information on a physical location of the key within the keyboard and/or attribute information based on the type of the keyboard.

In an embodiment, the adjacency distance may be a sum of one or more L1 distances. The L1 distance may refer to a Manhattan distance. The L1 distance may be calculated for each character. The electronic device 201 may calculate an L1 distance between a character included in a search word and a character included in an index word, based on the vector included in the keyboard layout. The electronic device 201 may calculate an adjacency distance between a search word and an index word by collecting L1 distances.

According to an embodiment, the electronic device 201 may be implemented as at least one of a smartphone, a tablet personal computer (PC), a mobile phone, a speaker (e.g., an artificial intelligence (AI) speaker), a video phone, an e-book reader, a desktop PC, a laptop PC, a netbook computer, a workstation, a server, a personal digital assistant (PDA), a portable multimedia player (PMP), an MPEG-1 Audio Layer-3 (MP3) player, a mobile medical device, a camera, or a wearable device.

Referring to FIG. 2, according to an embodiment, the electronic device 201 may include an input module 210 (e.g., the input module 150 of FIG. 1). The electronic device 201 may include one or more processors 220 (e.g., the processor 120 of FIG. 1). The electronic device 201 may include memory 230 (e.g., the memory 130 of FIG. 1).

According to an embodiment, the input module 210 may receive instructions or data to be used by a component (e.g., the processor 120) of the electronic device 201 from the outside (e.g., a user) of the electronic device 201. The input module 210 may include a keyboard. The input module 210 may include a hardware keyboard and/or a software keyboard. The processor 220 (e.g., an AP) may access the memory 230 and execute one or more instructions. The processor 220 may execute a search engine 221. The memory 230 may store data used by at least one component (e.g., the processor 220) of the electronic device 201. The memory 230 may store an index word dictionary 231.

According to an embodiment, the processor 220 may be implemented as circuitry (e.g., processing circuitry) such as an SoC or an IC. The processor 220 may include one or more processors. For example, the processor 220 may include a combination of one or more processors, such as a CPU, a GPU, an MPU, an AP, and a CP.

According to an embodiment, the memory 230 may include one or more memories. Instructions stored in the memory 230 may be stored in single memory. Instructions stored in the memory 230 may be divided and stored in a plurality of memories. Instructions stored in the memory 230 may be individually or collectively executed by the processor 220 to cause the electronic device 201 to perform and/or control a search method described with reference to FIGS. 2, 3, 4A, 4B, 5A to 5D, 6, 7A, 7B, 8, 9A to 9C, 10, and 11. Instructions stored in the memory 230 may be individually or collectively executed by a plurality of processors to cause the electronic device 201 to perform and/or control the search method described with reference to FIGS. 2, 3, 4A, 4B, 5A to 5D, 6, 7A, 7B, 8, 9A to 9C, 10, and 11.

According to an embodiment, the search engine 221 may receive a search word from a user and return a search result. The search engine 221 may return an application running within the electronic device 201 as a search result. However, the search result to be returned by the search engine 221 is not limited to an application. The search engine 221 may return documents and/or images in response to a search word.

According to an embodiment, the search engine 221 may correct the search word received from the user through a search word correction module 222. The search word processed through the search word correction module 222 may be an index word (e.g., a component of the index word dictionary 231 including index words processed for search). The search engine 221 may perform a search based on the search word or corrected search word (e.g., an index word) received from the user through a search module 224. The search engine 221 may update (and/or generate) the index word dictionary 231 through an index module 223.

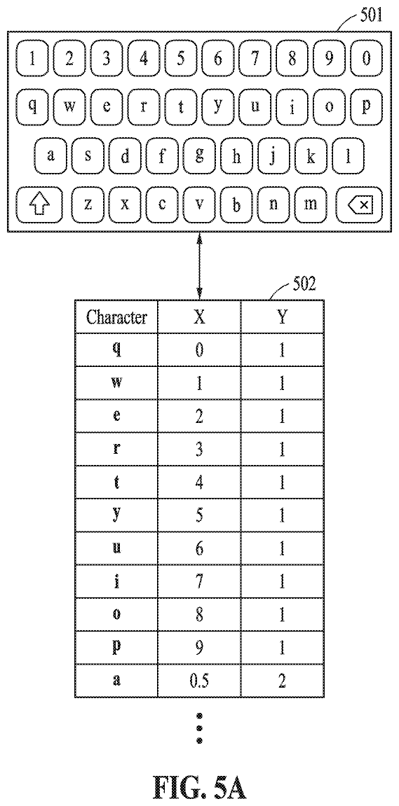

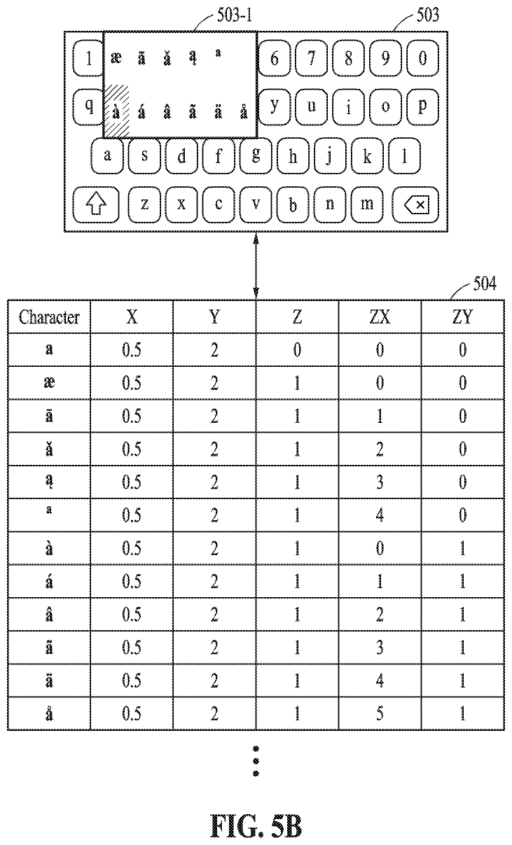

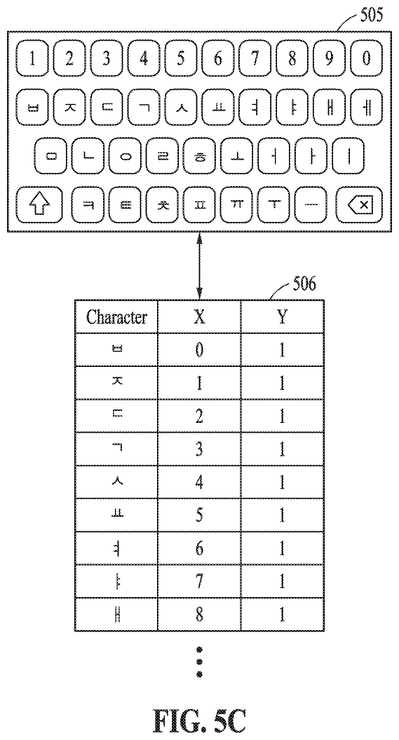

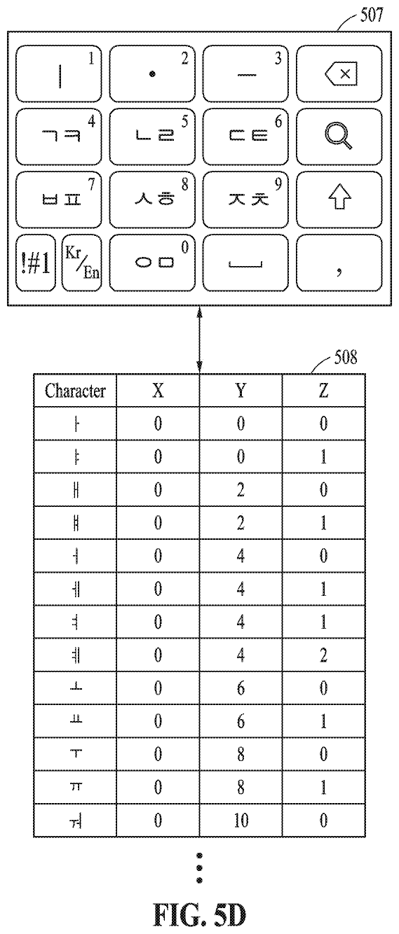

Referring to FIG. 3, according to an embodiment, a search word correction module 300 (e.g., the search word correction module 222 of FIG. 2) may include a first search word correction module 310 and a second search word correction module 320. The first search word correction module 310 may be intended to support a keyboard fuzzy function. The first search word correction module 310 may estimate a keyboard layout (e.g., see FIGS. 5A to 5D). The second search word correction module 320 may be intended to support other search word correction functions (e.g., a synonym correction function, morpheme-based correction function, translation result correction function, grapheme segmentation function, initial consonant-based correction function, edit distance-based correction function, and similar pronunciation correction function).

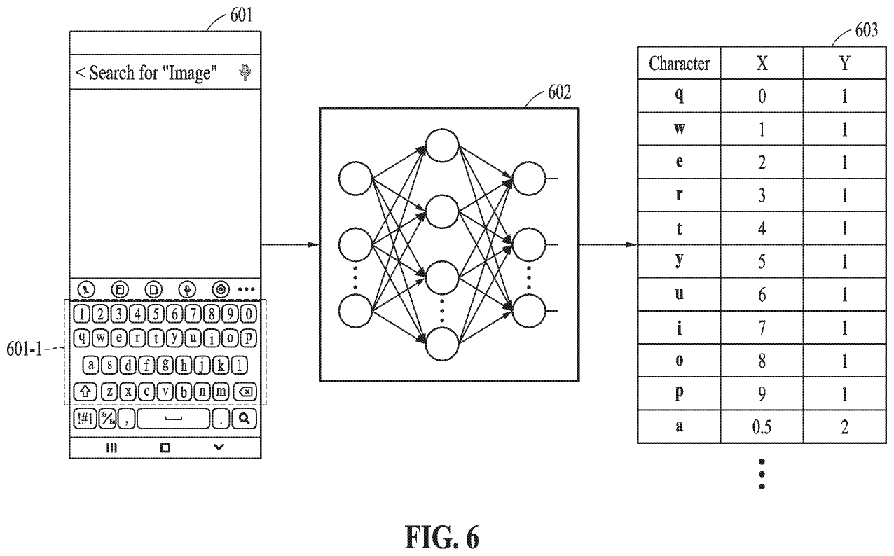

According to an embodiment, a keyboard image analysis module 311 may analyze a keyboard image. The keyboard image analysis module 311 may be performed when the electronic device 201 has screen capture permission. The keyboard image analysis module 311 may capture a screen displayed by the electronic device 201. The keyboard image analysis module 311 may obtain a keyboard layout from a keyboard image included in the screen, based on a first neural network model. Operations of the keyboard image analysis module 311 are described in detail with reference to FIG. 6.

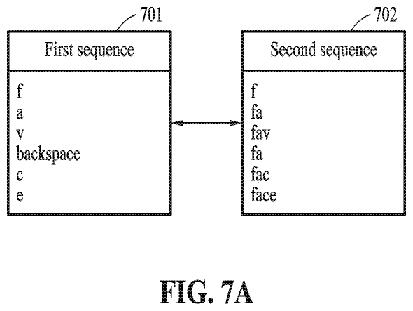

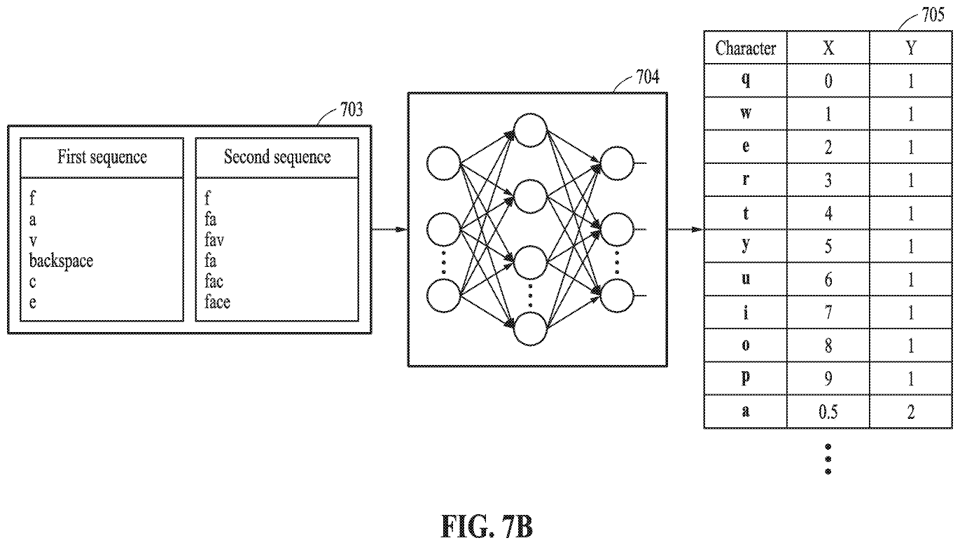

According to an embodiment, a keyboard input analysis module 312 may analyze an input (e.g., text) input via a keyboard. The keyboard input analysis module 312 may be performed when the electronic device 201 does not have screen capture permission. The keyboard input analysis module 312 may obtain a type of a keyboard from at least one of a first sequence (e.g., inputs to the keyboard, classified in chronological order) (e.g., see first sequence 701 of FIG. 7A) or a second sequence (e.g., search words that change according to inputs to the keyboard, classified in chronological order) (e.g., see second sequence 702 of FIG. 7A) associated with the search word, based on a second neural network model. The keyboard input analysis module 312 may obtain the keyboard layout based on the type of the keyboard. Operations of the keyboard input analysis module 312 are described in detail with reference to FIGS. 7A and 7B.

According to an embodiment, a keyboard layout management module 313 may manage the keyboard layout output by the keyboard image analysis module 311 and/or the keyboard input analysis module 312.

According to an embodiment, an index word determination module 314 may select an index word in which an adjacency distance to a search word (e.g., a user input) is less than a threshold value, based on the keyboard layout. The keyboard layout may include a vector corresponding to a key included in the keyboard. The vector may include information on a physical location of the key within the keyboard and/or attribute information based on the type of the keyboard. The adjacency distance may be a sum of one or more L1 distances. The L1 distance may refer to a Manhattan distance. The L1 distance may be calculated for each character. The electronic device 201 may calculate an L1 distance between a character included in a search word and a character included in an index word, based on the vector included in the keyboard layout. The electronic device 201 may calculate an adjacency distance between a search word and an index word by collecting L1 distances.

According to an embodiment, an operation of the search word correction module 300 may be based on an instant search scheme in which search results are updated for each input to the keyboard. The operation of the search word correction module 300 may be triggered when the number of characters included in the search word is greater than a threshold value. The operation of the search word correction module 300 may be triggered when there is no search result corresponding to the search word. The operation of the search word correction module 300 may be performed as a fallback mechanism according to a search policy of the electronic device 201.

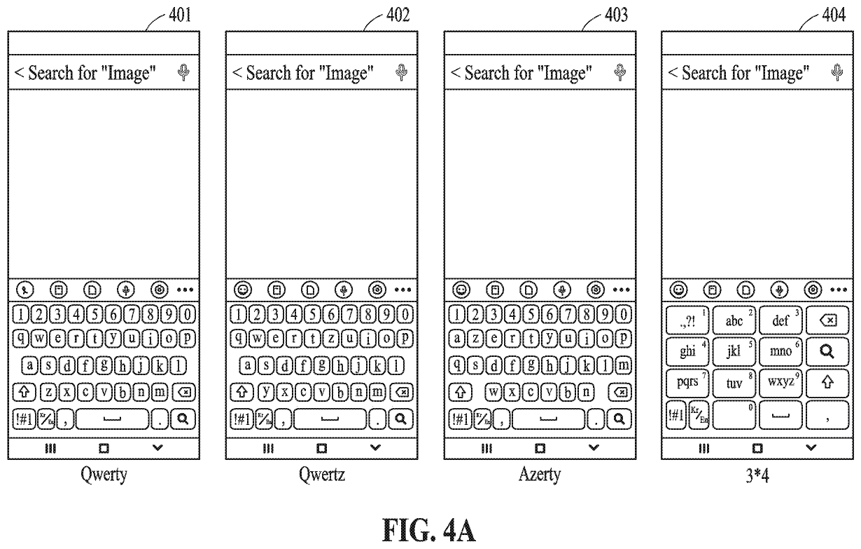

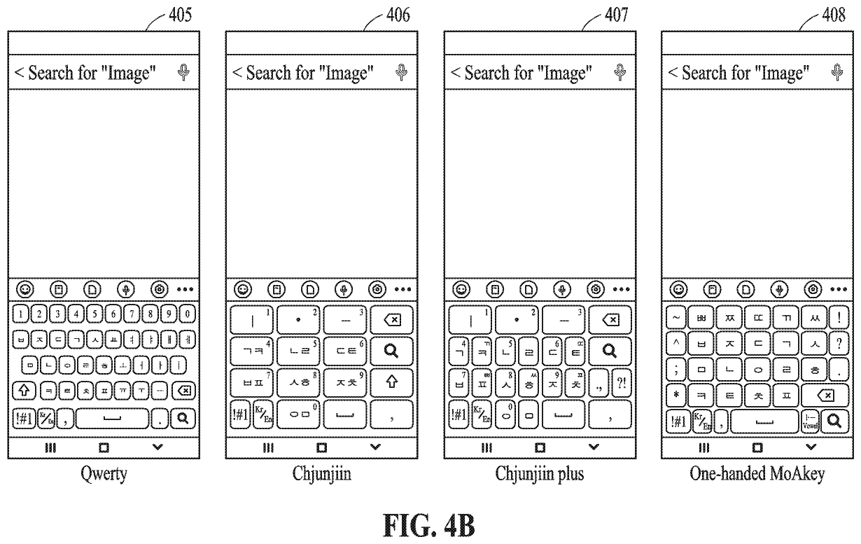

FIGS. 4A and 4B are diagrams illustrating types of keyboards according to various embodiments of the disclosure. FIGS. 5A to 5D are diagrams illustrating keyboard layouts according to various embodiments of the disclosure.

Referring to FIG. 4A, according to an embodiment, various types of English keyboards are illustrated. A keyboard type 401 may be a qwerty type. A keyboard type 402 may be a qwertz type. A keyboard type 403 may be an azerty type. A keyboard type 404 may be a 3*4 type.

Referring to FIG. 4B, according to an embodiment, various types of Korean keyboards are illustrated. A keyboard type 405 may be a qwerty type. A keyboard type 406 may be a Chunjiin type. A keyboard type 407 may be a Chunjiin plus type. A keyboard type 408 may be a one-handed MoAKey type.

Referring to FIG. 5A, according to an embodiment, a keyboard layout 502 of a qwerty type English keyboard 501 is illustrated. The keyboard layout 502 may include information (e.g., X, Y) on a physical location of a key within the keyboard. For example, a q key may be located one space below a key (e.g., a 1 key) located at the top left of the qwerty type English keyboard 501. The physical location of the q key may be expressed as (0, 1). For example, a w key may be located one space to the right and one space below the key (e.g., the 1 key) located at the top left of the qwerty type English keyboard 501. The physical location of the w key may be expressed as (1, 1). For example, an a key may be located half a space to the right and two spaces below the key (e.g., the 1 key) located at the top left of the qwerty type English keyboard 501. The physical location of the a key may be expressed as (0.5, 2).

Referring to FIG. 5B, according to an embodiment, a keyboard layout 504 of a qwerty type English keyboard 503 supporting Latin is illustrated. The keyboard layout 504 may also include attribute information (e.g., Z, ZX, ZY) on a key, as well as information (e.g., X, Y) on a physical location of the key within the keyboard. For example, an æ key may require additional input compared to the a key described above with reference to FIG. 5A. The æ key may be located at the top left of a displayed Latin input interface 503-1 by holding down the a key touch. The æ key may be expressed as (0.5, 2, 1, 0, 0) through the physical location information (e.g., X, Y) of the key and the attribute information (e.g., Z, ZX, ZY) of the key. For example, an a key may be located one space to the right of æ in the displayed Latin input interface 503-1 by holding the a key touch. The a key may be expressed as (0.5, 2, 1, 1, 0) through the physical location information (e.g., X, Y) of the key and the attribute information (e.g., Z, ZX, ZY) of the key.

Referring to FIG. 5C, according to an embodiment, a keyboard layout 506 of a qwerty type Korean keyboard 505 is illustrated. The keyboard layout 506 may include information (e.g., X, Y) on a physical location of a key within the keyboard. For example, a [symbol] key may be located one space below a key (e.g., a 1 key) located at the top left of the qwerty type Korean Keyboard 505. The physical location of the [symbol] key may be expressed as (0,1). For example, a [symbol] key may be located one space to the right and one space below the key (e.g., the 1 key) located at the top left of the qwerty type Korean keyboard 505. The physical location of the [symbol] key may be expressed as (1, 1).

Referring to FIG. 5D, according to an embodiment, a keyboard layout 508 of a Chunjiin type Korean keyboard 507 is illustrated. The keyboard layout 508 may include attribute information (e.g., X, Y, Z) of a character rather than a physical location of a key. In the keyboard layout 508, the attribute information of a character may be attribute information for inputting a character (e.g., a consonant or a vowel). For example, to input a vowel [symbol] , a | key located at the top left of the Chunjiin type Korean keyboard 507 and a ● key located one space to the right should be input. For example, to input a vowel [symbol] , the | key located at the top left of the Chunjiin type Korean keyboard 507 should be input once, and then the ● key located one space to the right should be input twice. Therefore, referring to the keyboard layout 508, the vowels [symbol] and [symbol] , which have different input counts for the ● key, may only have a difference of 1 in the Z value. For keyboard types where a single character (e.g., a consonant or vowel) is completed by combining a plurality of keys and/or a plurality of inputs, the keyboard layout may be expressed as attribute information of the character.

FIG. 6 is a diagram illustrating a method of estimating a keyboard layout according to an embodiment of the disclosure.

Referring to FIG. 6, according to an embodiment, an electronic device (e.g., the electronic device 201 of FIG. 2) may analyze a keyboard image 601-1 to obtain a keyboard layout 603. The electronic device 201 may capture a screen 601 it displays. The electronic device 201 may obtain the keyboard layout 603 from the keyboard image 601-1 included in the screen 601, based on a first neural network model 602. The keyboard layout 603 may include a vector corresponding to a key included in the keyboard.

According to an embodiment, the first neural network model 602 may be an overall model in which artificial neurons (nodes) that form a network by combining synapses change the strength of synaptic combination through learning, thereby having problem-solving capabilities. The first neural network model 602 may be learned based on learning data in which a keyboard image and a keyboard layout are mapped.

According to an embodiment, neurons of the first neural network model 602 may include a combination of weights or biases. The first neural network model 602 may include one or more layers including one or more neurons or nodes. The first neural network model 602 may infer a desired result from an arbitrary input by changing the weights of neurons through learning.

According to an embodiment, the first neural network model 602 may include a deep neural network. The first neural network model 602 may include a convolutional neural network (CNN), a recurrent neural network (RNN), a perceptron, a multilayer perceptron, a feed forward (FF), a radial basis network (RBF), a deep feed forward (DFF), long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), or a generative adversarial network (GAN). The operation of FIG. 6 may be performed when the electronic device 201 has screen capture permission.

FIGS. 7A and 7B are diagrams illustrating a method of estimating a keyboard layout according to various embodiments of the disclosure.

In an embodiment, an electronic device (e.g., the electronic device 201 of FIG. 2) may be required to estimate a keyboard layout even when the electronic device does not have screen capture permission. The electronic device 201 may estimate the keyboard layout by analyzing text input via the keyboard.

Referring to FIG. 7A, according to an embodiment, sequences 701 and 702 associated with a search word (e.g., a user input) (e.g., a face) are illustrated. The keyboard for inputting the search word (e.g., face) may be a qwerty type keyboard. The first sequence 701 associated with the search word (e.g., face) may be a sequence of inputs to the keyboard classified in chronological order (e.g., f, a, v, backspace, c, e). The second sequence 702 associated with the search word (e.g., face) may be a sequence of search words that change according to inputs to the keyboard, classified in chronological order (e.g., f, fa, fav, fa, fac, face). The electronic device 201 may obtain the first sequence 701 and the second sequence 702 based on the search word (e.g., face).

Referring to FIG. 7B, the electronic device 201 may obtain a keyboard type based on sequences 703 to which the first sequence 701 and the second sequence 702 are mapped, based on a second neural network model 704. The electronic device 201 may estimate a keyboard layout 705 based on the keyboard type. The second neural network model 704 may be learned based on learning data to which the first sequence, the second sequence, and the keyboard type are mapped. The second neural network model 704 may be based on a character-level RNN.

According to an embodiment, the electronic device 201 may use typo patterns (e.g., typo identification based on backspace input recognition). However, in some cases, a typo pattern may not be required. In FIG. 7B, typo patterns included in the sequences 703 to which the first sequence 701 and the second sequence 702 are mapped are used, but embodiments are not limited thereto. For example, in the case of a 3*4 type English keyboard, the type of the keyboard may be sufficiently identified with only the second sequence (e.g., d, e, f, fa, faa, fab, fac, facd, face) associated with the search word (e.g., face). A type of keyboard in which a single character is determined through multiple inputs, such as the 3*4 type English keyboard, may be sufficiently identified with only the second sequence. The electronic device 201 may estimate the keyboard layout based on the second sequence.

In an embodiment, the method of estimating the keyboard layout may not be limited to a method using a neural network model. The keyboard layout may also be obtained directly from within the electronic device 201. For example, an operating system (e.g., the operating system 142 of FIG. 1) of the electronic device 201 may manage settings related to the keyboard layout, and the electronic device 201 may also obtain the keyboard layout using an arbitrary library or an arbitrary application programming interface (API).

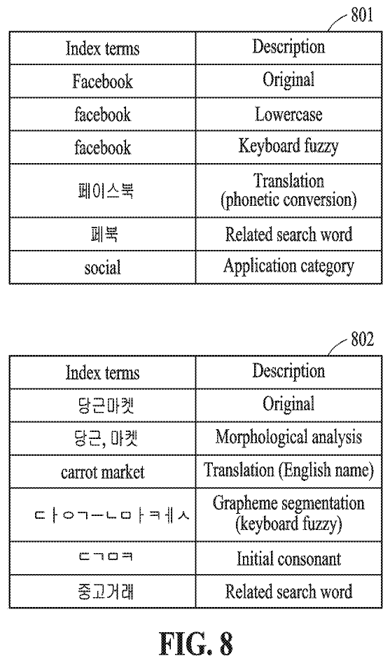

FIG. 8 is a diagram illustrating an index word dictionary according to an embodiment of the disclosure.

Referring to FIG. 8, according to an embodiment, examples of index terms (e.g., 801 and 802) stored in an index word dictionary (e.g., the index word dictionary 231 of FIG. 2) are illustrated. The index word dictionary may include index terms processed for searching. The index terms 801 may be a set of index terms associated with a search target (e.g., facebook application). The index terms 802 may be a set of index terms associated with a search target (e.g., [symbol] application).

According to an embodiment, the index terms 801 may include an original index term (e.g., Facebook) of a search target (e.g., facebook application), a lowercase index term (e.g., facebook) of the search target (e.g., facebook application), an index term (e.g., facebook) for keyboard fuzzing of the search target (e.g., facebook application), an index term (e.g., [symbol] ) corresponding to a translation result (e.g., phonetic conversion) of the search target (e.g., facebook application), an index term (e.g., [symbol] ) corresponding to a related search word of the search target (e.g., facebook application), and an index term (e.g., social) corresponding to an application category of the search target (e.g., facebook application).

According to an embodiment, the index terms 802 may include an original index term (e.g., [symbol] ) of a search target (e.g., [symbol] application), an index term (e.g., [symbol] ) corresponding to a morphological analysis result of the search target (e.g., [symbol] application), an index term (e.g., carrot market) corresponding to a translation result (e.g., English name) of the search target (e.g., [symbol] application), an index term (e.g., [symbol] [symbol] ) corresponding to a grapheme segmentation result of the search target (e.g., [symbol] application), an index term (e.g., [symbol] ) corresponding to an initial consonant of the search target (e.g., [symbol] application), and an index term (e.g., [symbol] ) corresponding to a related search word of the search target (e.g., [symbol] application). For Korean text, to support the keyboard fuzzy function, an index term corresponding to a grapheme segmentation result may have to be included in the index word dictionary.

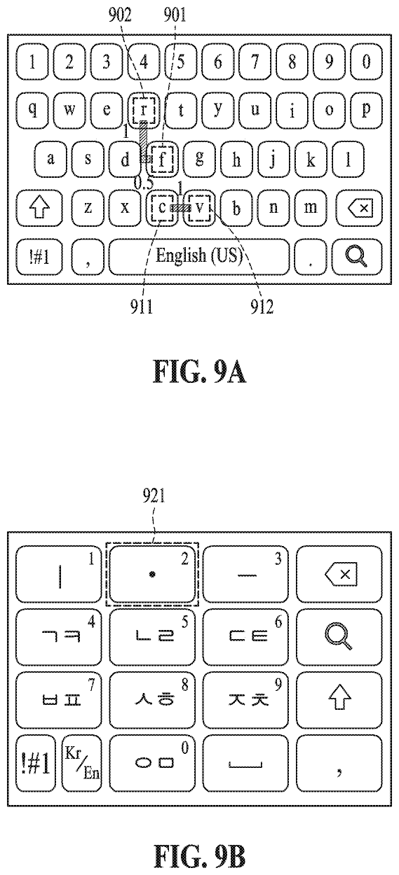

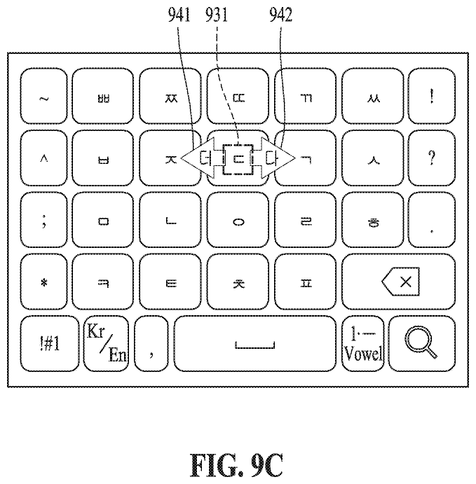

FIGS. 9A to 9C are diagrams illustrating an operation of calculating an adjacency distance according to various embodiments of the disclosure.

According to an embodiment, an electronic device (e.g., the electronic device 201 of FIG. 2) may select an index word in which an adjacency distance to a search word (e.g., a user input) is less than a threshold value, based on a keyboard layout. The adjacency distance may be a sum of one or more L1 distances. The L1 distance may refer to a Manhattan distance. The L1 distance may be calculated for each character. The keyboard layout may include a vector corresponding to a key included in the keyboard. The electronic device 201 may calculate an L1 distance between a character included in a search word and a character included in an index word, based on the vector included in the keyboard layout. The electronic device 201 may obtain an adjacency distance between a search word and an index word by collecting L1 distances.

Referring to FIG. 9A, according to an embodiment, the electronic device 201 may calculate an adjacency distance between a search word (e.g., rave) and an index word (e.g., facebook). A keyboard illustrated in FIG. 9A may be a qwerty type keyboard. An L1 distance between a character (e.g., r) 902 included in the search word (e.g., rave) and a character (e.g., f) 901 included in the index word (e.g., facebook) may be 1.5 (e.g., 1 along a y-axis and 0.5 along an x-axis). An L1 distance between a character (e.g., a) included in the search word (e.g., rave) and a character (e.g., a) included in the index word (e.g., facebook) may be 0. An L1 distance between a character (e.g., v) 912 included in the search word (e.g., rave) and a character (e.g., c) 911 included in the index word (e.g., facebook) may be 1. An L1 distance between a character (e.g., e) included in the search word (e.g., rave) and a character (e.g., e) included in the index word (e.g., facebook) may be 0. The electronic device 201 may calculate an adjacency distance (e.g., 2.5) between the search word (e.g., rave) and the index word (e.g., facebook) by collecting the L1 distances (e.g., 1.5, 0, 1, and 0). For the same search word-index word pair, the adjacency distance may vary depending on the keyboard type (or keyboard layout). Accordingly, even when the same search word is input to the electronic device 201, search word correction results (e.g., index words) may differ depending on the keyboard type used to input the search word. Even when the same search word is input to the electronic device 201, a returned search result may differ depending on the keyboard type.

Referring to FIG. 9B, according to an embodiment, the electronic device 201 may calculate the adjacency distance between a search word (e.g., [symbol] ) and an index word (e.g., [symbol] ). A keyboard illustrated in FIG. 9B may be a Chunjiin type keyboard (e.g., 406 of FIG. 4B). The search word (e.g., [symbol] ) and the index word (e.g., [symbol] ) may differ only in the vowels [symbol] and [symbol] . An L1 distance between the character (e.g., [symbol] ) included in the search word (e.g., [symbol] ) and the character (e.g., [symbol] ) included in the index word (e.g., [symbol] ) may be 1. As described above with reference to FIG. 5D, in order to input the vowel [symbol] , it may be necessary to input an | key located at the top left of the Chunjiin type Korean keyboard and a key 921 located one space to the right. For example, to input the vowel [symbol] , it may be necessary to input the | key located at the top left of the Chunjiin type Korean keyboard once, and then input the key 921 located one space to the right twice. Therefore, the L1 distance between the vowels [symbol] and [symbol] , which have different input counts of the key 921, may be 1. The adjacency distance between the search word (e.g., [symbol] ) and the index word (e.g., [symbol] ) may be 1.

Referring to FIG. 9C, according to an embodiment, the electronic device 201 may calculate the adjacency distance between a search word (e.g., [symbol] ) and an index word (e.g., [symbol] ). A keyboard illustrated in FIG. 9C may be a one-handed MoAKey type keyboard (e.g., 408 of FIG. 4B). The search word (e.g., [symbol] ) and the index word (e.g., [symbol] ) may differ only in the vowels [symbol] and [symbol] . An L1 distance between the character (e.g., [symbol] ) included in the search word (e.g., [symbol] ) and the character (e.g., [symbol] ) included in the index word (e.g., [symbol] ) may be 1. In order to input the vowel [symbol] , it may be necessary to drag to the left (e.g., 941) on the one-handed MoAKey type keyboard (e.g., 931). In order to input the vowel [symbol] , it may be necessary to drag to the right (e.g., 942) on the one-handed MoAKey type keyboard (e.g., 931). Therefore, the L1 distance between the vowels [symbol] and [symbol] with different drag directions may be 1. The adjacency distance between the search word (e.g., [symbol] ) and the index word (e.g., [symbol] ) may be 1.

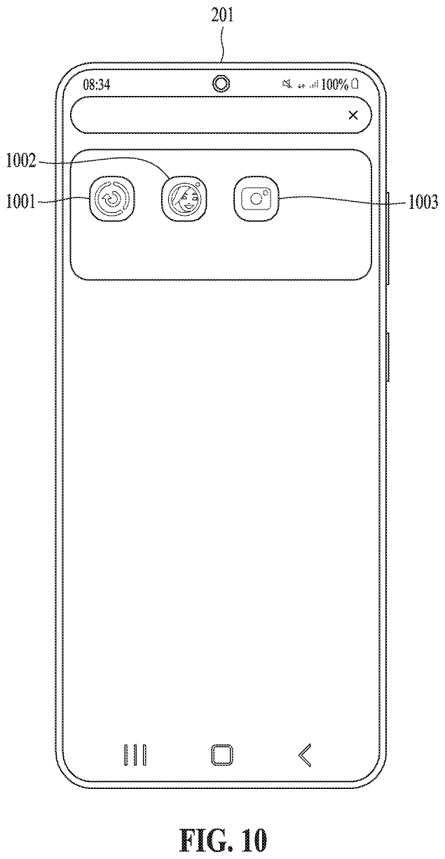

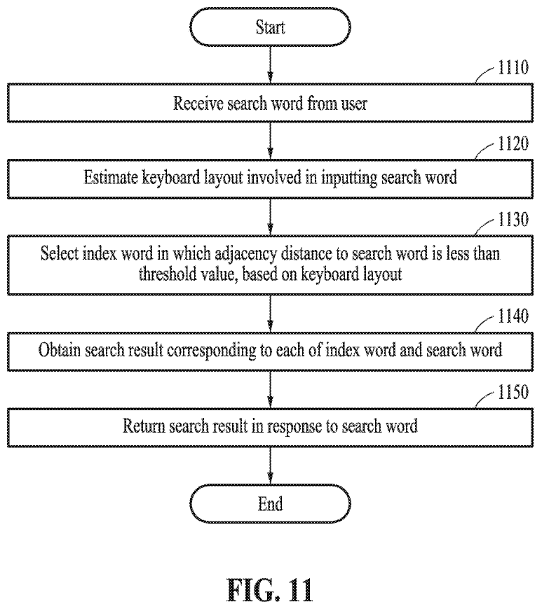

FIG. 10 is an example of a search result returned by an electronic device according to an embodiment of the disclosure.

Referring to FIG. 10, according to an embodiment, the electronic device 201 (e.g., the electronic device 101 of FIG. 1) may return search results (e.g., 1001, 1002, and 1003) (e.g., application search results) corresponding to a search word (e.g., cane). The search results (e.g., 1001, 1002, and 1003) may be displayed by being arranged in order of a smallest adjacency distance. When the adjacency distances are the same, the search results may be displayed according to an existing policy (e.g., arranged in alphabetical order).

In an embodiment, the electronic device 201 may be based on an instant search scheme (e.g., a scheme in which search results are updated with each input to the keyboard). In order to prevent missearch, the electronic device 201 may perform the keyboard fuzzy function described above with reference to FIGS. 2, 3, 4A, 4B, 5A to 5D, 6, 7A, 7B, 8, and 9A to 9C when the number of characters included in the search word is greater than a threshold value (e.g., 4).

According to an embodiment, the electronic device 201 may perform the keyboard fuzzy function according to a fallback mechanism, when no search result corresponding to the search word exists.

FIG. 11 is a flowchart illustrating an operation method of an electronic device according to an embodiment of the disclosure.

Operations 1110 to 1150 may be performed sequentially but not necessarily. For example, an order of each of operations 1110 to 1150 may be changed, and at least two operations may be performed in parallel.

According to an embodiment, operations 1110 to 1150 may be understood to be performed in a processor (e.g., the processor 220 of FIG. 2) of an electronic device (e.g., the electronic device 201 of FIG. 2).

In operation 1110, an electronic device according to an embodiment may receive a search word from a user.

In operation 1120, the electronic device according to an embodiment may estimate a keyboard layout of a keyboard used to input the search word.

In operation 1130, the electronic device according to an embodiment may select an index word in which an adjacency distance to the search word is less than a threshold value, based on the keyboard layout.

In operation 1140, the electronic device according to an embodiment may obtain a search result corresponding to each of the index word and the search word.

In operation 1150, the electronic device according to an embodiment may return the search result in response to the search word.

An operation method of an electronic device (e.g., the electronic device 101 of FIG. 1 or the electronic device 201 of FIG. 2) according to an embodiment may include receiving a search word from a user. The operation method may include estimating a keyboard layout of a keyboard used to input the search word. The operation method may include selecting an index word in which an adjacency distance to the search word is less than a threshold value, based on the keyboard layout. The operation method may include obtaining a search result corresponding to each of the index word and the search word. The operation method may include returning the search result in response to the search word.

According to an embodiment, the estimating of the keyboard layout may include capturing a screen displayed by the electronic device. The estimating of the keyboard layout may include obtaining the keyboard layout from a keyboard image included in the screen, based on a first neural network model.

According to an embodiment, the estimating of the keyboard layout may include obtaining a type of the keyboard from at least one of a first sequence or a second sequence associated with the search word, based on a second neural network model. The estimating of the keyboard layout may include obtaining the keyboard layout based on the type of the keyboard. The first sequence may be a sequence of inputs to the keyboard classified in chronological order. The second sequence may be a sequence of search words that change according to the inputs to the keyboard, classified in chronological order.

According to an embodiment, the keyboard layout may include a vector corresponding to a key included in the keyboard. The vector may include at least one of information on a physical location of the key within the keyboard; or attribute information based on the type of the keyboard.

In an embodiment, the adjacency distance may be a sum of one or more L1 distances, each of which may be an L1 distance between a character included in the search word and a character included in the index word, based on the vector included in the keyboard layout.

According to an embodiment, the index word may be selected from an index word dictionary including index words processed for searching.

According to an embodiment, the search result may be displayed by being arranged in order of a smallest adjacency distance.

According to an embodiment, the returning of the search result may be based on an instant search scheme in which search results are updated for each input to the keyboard.

According to an embodiment, the operation method may be triggered when the number of characters included in the search word is greater than a threshold value or when no search result corresponding to the search word exists.

According to an embodiment, the operation method may be performed as a fallback mechanism according to a search policy of the electronic device.

According to an embodiment, the index word dictionary may include at least one of an original index word of a search target, an index word corresponding to a morphological analysis result of the search target, an index word corresponding to a translation result of the search target, an index word corresponding to a grapheme segmentation result of the search target, an index word corresponding to an initial consonant of the search target, an index word corresponding to a category of the search target, or an index word corresponding to a related search word of the search target.

An electronic device according to an embodiment (e.g., the electronic device 101 of FIG. 1 or the electronic device 201 of FIG. 2) may include one or more processors (e.g., the processor 120 of FIG. 1 or the processor 220 of FIG. 2). The electronic device may include memory (e.g., the memory 130 of FIG. 1 or the memory 230 of FIG. 2) storing instructions. The instructions, when individually or collectively executed by the one or more processors, may cause the electronic device to receive a search word from a user. The instructions, when individually or collectively executed by the one or more processors, may cause the electronic device to estimate a keyboard layout of a keyboard used to input the search word. The instructions, when individually or collectively executed by the one or more processors, may cause the electronic device to select an index word in which an adjacency distance the search word is less than a threshold value, based on the keyboard layout. The instructions, when individually or collectively executed by the one or more processors, may cause the electronic device to obtain a search result corresponding to each of the index word and the search word. The instructions, when individually or collectively executed by the one or more processors, may cause the electronic device to return the search result in response to the search word.

According to an embodiment, the instructions, when individually or collectively executed by the one or more processors, may cause the electronic device to capture a screen displayed by the electronic device 101 or 201. The instructions, when individually or collectively executed by the one or more processors, may cause the electronic device to obtain the keyboard layout from a keyboard image included in the screen, based on a first neural network model.

According to an embodiment, the instructions, when individually or collectively executed by the one or more processors, may cause the electronic device to obtain a type of the keyboard from at least one of a first sequence or a second sequence associated with the search word, based on a second neural network model. The instructions, when individually or collectively executed by the one or more processors, may cause the electronic device to obtain the keyboard layout based on the type of the keyboard. The first sequence may be a sequence of inputs to the keyboard classified in chronological order. The second sequence may be a sequence of search words that change according to the inputs to the keyboard, classified in chronological order.

According to an embodiment, the keyboard layout may include a vector corresponding to a key included in the keyboard. The vector may include at least one of information on a physical location of the key within the keyboard; or attribute information based on the type of the keyboard.

In an embodiment, the adjacency distance may be a sum of one or more L1 distances. Each of the one or more L1 distances may be an L1 distance between a character included in the search word and a character included in the index word, based on the vector included in the keyboard layout.

According to an embodiment, the index word may be selected from an index word dictionary including index words processed for searching.

According to an embodiment, the search result may be displayed by being arranged in order of a smallest adjacency distance.

According to an embodiment, the electronic device may be based on an instant search scheme in which search results are updated for each input to the keyboard.

According to an embodiment, the index word dictionary may include at least one of an original index word of a search target, an index word corresponding to a morphological analysis result of the search target, an index word corresponding to a translation result of the search target, an index word corresponding to a grapheme segmentation result of the search target, an index word corresponding to an initial consonant of the search target, an index word corresponding to a category of the search target, or an index word corresponding to a related search word of the search target.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., program) including one or more instructions that are stored in a storage medium (e.g., internal memory 136 or external memory 138) that is readable by a machine (e.g., electronic device). For example, a processor (e.g., processor) of the machine (e.g., electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An operation method performed by an electronic device, the operation method comprising:
receiving, by the electronic device, a search word from a user;
estimating, by the electronic device, a keyboard layout of a keyboard used to input the search word;
selecting, by the electronic device, an index word in which an adjacency distance to the search word is less than a threshold value, based on the keyboard layout;
obtaining, by the electronic device, a search result corresponding to each of the index word and the search word; and
returning, by the electronic device, the search result in response to the search word.

2. The operation method of claim 1, wherein the estimating of the keyboard layout comprises:
capturing a screen displayed by the electronic device; and
obtaining the keyboard layout from a keyboard image included in the screen, based on a first neural network model.

3. The operation method of claim 1,
wherein the estimating of the keyboard layout comprises:
obtaining a type of the keyboard from at least one of a first sequence or a second sequence associated with the search word, based on a second neural network model, and
obtaining the keyboard layout based on the type of the keyboard,
wherein the first sequence is a sequence of inputs to the keyboard, classified in chronological order, and
wherein the second sequence is a sequence of search words that change according to the inputs to the keyboard, classified in chronological order.

4. The operation method of claim 3,
wherein the keyboard layout comprises:
a vector corresponding to a key included in the keyboard, and
wherein the vector comprises at least one of:
information on a physical location of the key within the keyboard, or
attribute information based on the type of the keyboard.

5. The operation method of claim 4,
wherein the adjacency distance is:
a sum of one or more L1 distances, and
wherein each of the one or more L1 distances is:
an L1 distance between characters included in the search word and characters included in the index word, based on the vector included in the keyboard layout.

6. The operation method of claim 1, wherein the index word is selected from an index word dictionary including index words processed for search.

7. An electronic device comprising:
memory, comprising one or more storage media, storing instructions; and
one or more processors communicatively coupled to the memory,
wherein the instructions, when executed by the one or more processors individually or collectively, cause the electronic device to:
receive a search word from a user,
estimate a keyboard layout of a keyboard used to input the search word,
select an index word in which an adjacency distance to the search word is less than a threshold value, based on the keyboard layout,
obtain a search result corresponding to each of the index word and the search word, and
return the search result in response to the search word.

8. The electronic device of claim 7, wherein the instructions, when executed individually or collectively by the one or more processors, cause the electronic device to:
capture a screen displayed by the electronic device, and
obtain the keyboard layout from a keyboard image included in the screen, based on a first neural network model.

9. The electronic device of claim 7,
wherein the instructions, when executed individually or collectively by the one or more processors, cause the electronic device to:
obtain a type of the keyboard from at least one of a first sequence or a second sequence associated with the search word, based on a second neural network model, and
obtain the keyboard layout based on the type of the keyboard,
wherein the first sequence is a sequence of inputs to the keyboard, classified in chronological order, and
wherein the second sequence is a sequence of search words that change according to the inputs to the keyboard, classified in chronological order.

10. The electronic device of claim 9,
wherein the keyboard layout comprises:
a vector corresponding to a key included in the keyboard, and
wherein the vector comprises at least one of:
information on a physical location of the key within the keyboard, or
attribute information based on the type of the keyboard.

11. The electronic device of claim 10,
wherein the adjacency distance is a sum of one or more L1 distances, and
wherein each of the one or more L1 distances is an L1 distance between characters included in the search word and characters included in the index word, based on the vector included in the keyboard layout.

12. The electronic device of claim 9, wherein the index word is selected from an index word dictionary including index words processed for search.

13. The electronic device of claim 7, wherein the search result is displayed by being arranged in order of a smallest adjacency distance.

14. The electronic device of claim 7, wherein the electronic device is based on an instant search scheme in which a search result is updated for each input to the keyboard.

15. The electronic device of claim 12, wherein the index word dictionary comprises at least one of:
an original index word of a search target, an index word corresponding to a morphological analysis result of the search target, an index word corresponding a translation result of the search target, an index word corresponding to a grapheme segmentation result of the search target, an index word corresponding to an initial consonant of the search target, an index word corresponding to a category of the search target, or an index word corresponding to a related search word of the search target.

16. One or more non-transitory computer-readable storage media storing one or more computer programs including computer-executable instructions that, when executed by one or more processors of an electronic device individually or collectively, cause the electronic device to perform operations, the operations comprising:
receiving, by the electronic device, a search word from a user;
estimating, by the electronic device, a keyboard layout of a keyboard used to input the search word;
selecting, by the electronic device, an index word in which an adjacency distance to the search word is less than a threshold value, based on the keyboard layout;
obtaining, by the electronic device, a search result corresponding to each of the index word and the search word; and
returning, by the electronic device, the search result in response to the search word.

17. The one or more non-transitory computer-readable storage media of claim 16, wherein the estimating of the keyboard layout comprises:
capturing a screen displayed by the electronic device; and
obtaining the keyboard layout from a keyboard image included in the screen, based on a first neural network model.

18. The one or more non-transitory computer-readable storage media of claim 16,
wherein the estimating of the keyboard layout comprises:
obtaining a type of the keyboard from at least one of a first sequence or a second sequence associated with the search word, based on a second neural network model, and
obtaining the keyboard layout based on the type of the keyboard,
wherein the first sequence is a sequence of inputs to the keyboard, classified in chronological order, and
wherein the second sequence is a sequence of search words that change according to the inputs to the keyboard, classified in chronological order.

19. The one or more non-transitory computer-readable storage media of claim 18,
wherein the keyboard layout comprises:
a vector corresponding to a key included in the keyboard, and
wherein the vector comprises at least one of:
information on a physical location of the key within the keyboard, or
attribute information based on the type of the keyboard.

20. The one or more non-transitory computer-readable storage media of claim 19,
wherein the adjacency distance is:
a sum of one or more L1 distances, and
wherein each of the one or more L1 distances is:
an L1 distance between characters included in the search word and characters included in the index word, based on the vector included in the keyboard layout.
